(19) United States
(12) Patent Application Publication
(10) Pub. No.: US 2005/0071318 A1
(43) Pub. Date: Mar. 31, 2005

(54) Complex table rendering and navigation with highly constrained devices

(75) Inventors: Barnaby L. Court, Morrisville, NC (US); Timothy J. O'Keefe, Rochester, MN (US); Elizabeth A. Schreiber, Cary, NC (US); David B. Styles, Cary, NC (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/675,487

(22) Filed: Sep. 30, 2003

(51) Int. Cl. G06F 17/30; G06F 17/00

(52) U.S. Cl. 707/2; 707/3; 707/100

(57) ABSTRACT

A method, system and apparatus for enabling complex table navigation in a highly constrained device. The method can include reducing a complex table defined in markup to a row range view, a set of row views and a set of record views. Individual ones of the record views can be navigably linked to selected ones of the row views, and individual ones of the row views can be further navigably linked to selected row ranges disposed in the row range view. Finally, the row range view can be presented responsive to a request to render the complex table in the highly constrained device.

### BACKGROUND OF THE INVENTION

1. Statement of the Technical Field

The present invention relates to the field of user interface rendering and more particularly to table rendering and navigation within devices having highly constrained display functionality.

2. Description of the Related Art

The conventional graphical user interface (GUI) has been widely used for many years. The primary function of the GUI includes providing user interface controls with which the end-user can interact with an underlying application. The common GUI includes many stock user interface controls, most of which, when combined, can accommodate most computer-human interactions required by an application. For example, the static text box control can be used to present text to the end-user while an edit box can permit the user to provide textual input to the application. A radio button control can provide for the exclusive selection of an element from among a field of elements, while a table can provide visual structure for organizing data within the GUI.

When user interface controls are displayed in a GUI, one must compromise between the amount of information which can be displayed within the display, and the amount of displayable space within the display in which a preferred amount of information can be presented. Where the display area must be reduced due to dimensional constraints, information that otherwise might be easily grouped and viewed within a larger display space often cannot be presented as a single set of cohesive and interrelated controls. This circumstance has been known to arise in the use of pervasive devices, including handheld computers and portable cellular telephones.

Modern network distributed applications enjoy a user interface typically defined within a markup language based document. Commercially ubiquitous content browsers interpret and render markup to produce the user interface within the display region of the content browser. In this way, the complexity and extent of a user interface defined within markup can be limited only by the display region of the device hosting the content browser. In particular, in the circumstance of a pervasive device, any user interface defined through markup can be somewhat constrained.

Intent based markup languages offer application developers a way to define a set of user interactions within a user interface in a manner which can be characterized as platform, device and application container independent. Tools that assist application developers in creating intent based markup language based documents generally encourage the application developer to capitalize upon a rich set of user interface controls and layouts in order to achieve a desirable user interface on a device capable of rendering a complex user interface. Pervasive devices, however, often are not considered capable of rendering a complex user interface.

Nevertheless, it remains possible to build an application based upon an intent based markup language wherein the user interface of the application can be hosted within both rich client platforms and constrained client devices, such as the personal digital assistant or a cellular telephone. Currently most applications utilize separate Java™ server pages and extensible style sheets to achieve device appropriate renderings. In particular, separate JSP and XSL logic can be defined to appropriately render content in a manner appropriate for a specific target platform and target device. Thus, while the use of JSP and XSL technology can eliminate the requirement to produce duplicate business logic for different platforms and devices, separate JSP and XSL logic still will be required to suitably render and manage an interface within different platforms and devices.

Rendering tables within constrained client devices can be particularly difficult where it is desirable to maintain only a single base markup language document defining the table. Conventional techniques for rendering a table within a constrained environment include removing unnecessary rows and columns from the table as described in U.S. Pat. No. 6,523,040 to Lo et al. Other conventional techniques can include the display of a row in a table as a column to accommodate the vertically oriented displays of cellular telephones, as described in U.S. Patent Application Publication No. 2002/0013165 by Ostergaard. Most rendering techniques involve the default display of a limited number of rows and columns of a table at one time as in U.S. Patent Application Publication 2002/0038384 by Kahn et al. Yet, none of the foregoing references address the problem of managing the navigation of a complex table within a constrained environment.

### SUMMARY OF THE INVENTION

The present invention addresses the deficiencies of the art in respect to rendering and managing the navigation of a complex table within a limited display and provides a novel and non-obvious method, system and apparatus for enabling complex table navigation, filtering and selecting with the display of a constrained device. A complex table rendering and navigation system which has been configured in accordance with the present invention can include one or more row range views, one or more row views, and one or more record views. Each of the row views can have an association with one of the row range views. Each of the record views can have an association with one of the row views.

A complex table processor can be coupled to an application server and programmed to reduce a complex table into the row range views, the row views and the record views. Moreover, a controller can be configured to map selected events and triggers originating within the views to others of the views. The controller can be further configured to map additional selected events and triggers originating within the views to the complex table. Notably, in a preferred aspect of the invention, a filter management view further can be provided for filtering the rows presented based upon one or more filtering criteria.

A method of enabling complex table navigation in a highly constrained device can include reducing a complex table defined in markup to a row range view, a set of row views and a set of record views. Individual ones of the record views can be navigably linked to selected ones of the row views, and individual ones of the row views can be further navigably linked to selected row ranges disposed in the row range view. Finally, the row range view can be presented responsive to a request to render the complex table in the highly constrained device.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a system for managing complex table navigation which has been configured in accordance with the present invention;

FIG. 2 is a block diagram illustrating a process for managing complex table navigation in the system of FIG. 1;

FIGS. 3A through 3D, taken together, are screen shot representations of a process of navigating a table rendered within the user interface of a limited display device; and,

FIGS. 4A and 4B, taken together, are screen shot representations of a filtering feature configured for operation with the navigation process of FIGS. 3A through 3D.

### DETAILED DESCRIPTION OF THE PREFERRED EMBODIMENTS

The present invention is a table management and navigation system, method and apparatus in which elements of a large, filterable, sortable table can be reduced to manageable, navigable chunks for display and manipulation within the display of a highly constrained device. Notably, the table can be reduced without requiring the modification of the underlying application. The table can be reduced in this manner by introducing a number of new views which collectively represent a consolidated view of the table, and a corresponding controller to handle navigation between the new views. By reducing the table into the manageable, navigable chunks, an end user can effectively navigate the table through the new views in a manner which remains transparent to the underlying application.

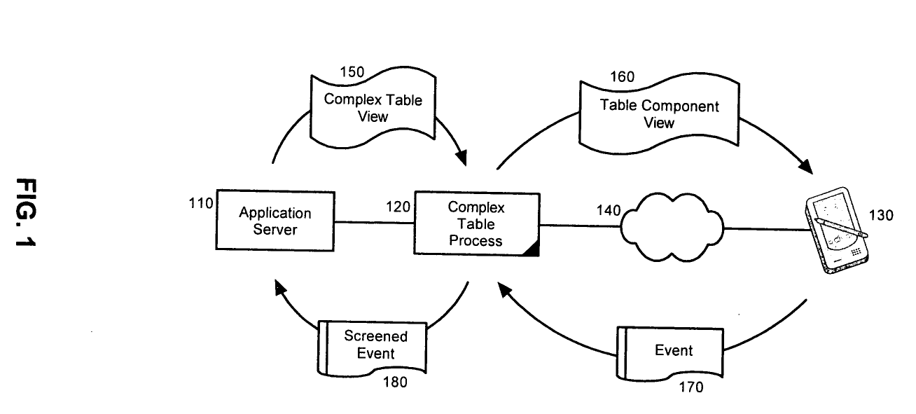

FIG. 1 is pictorial illustration of a system for managing complex table navigation which has been configured in accordance with the present invention. In accordance with the present invention, an application server 110 can serve markup as an interface to an application developed for distribution over a computer communications network 140 such as the global Internet. The markup defined interface can be rendered within both traditional client content browsing device, and also limited display devices 130 (only one limited display device illustrated for purposes of simplicity) such as pervasive devices. Within the markup defined interface, a complex table view 150 can be presented.

A complex table process 120 can be communicatively coupled to the application server 110 so that markup served by the application server 110, and more particularly, the complex table view 150, can be processed within the complex table process 120 prior to the delivery of the complex table view 150 to the limited display device 130. In this regard, the complex table process 120 can reduce the complex table view 150 to a set of progressive table component views 160. Each table component view 160 can be selectively rendered in the limited display device 130 at the command of the end user. Events generated through the interaction with the table component view 160 can be processed first in the complex table process 120. Where the event 170 is unique to the table component view 160 and bear no operable relation to the complex table view 150 such as the navigation between table component views 160, the event 170 can be processed within the complex table process 120. Otherwise, the screened event 180 can be passed to the application server 110 for processing as if the event had arisen through a singular rendering of the complex table view 150.

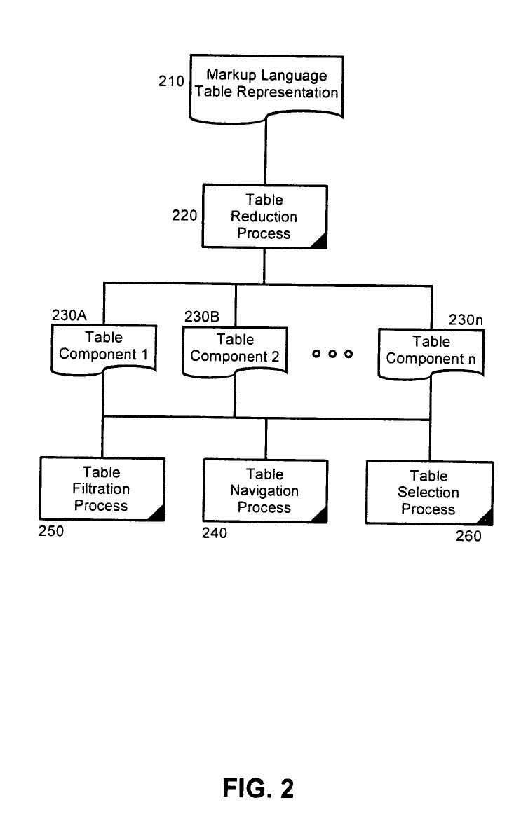

Importantly, by reducing the complex table view 150 into a set of reduced table component views 160 between which an end user can navigate, the complex table view 150 can be rendered in a way so as to facilitate the management and navigation of the complex table view 150 as a whole. In more particular illustration, FIG. 2 is a block diagram illustrating a process for managing complex table navigation in the system of FIG. 1. As shown in FIG. 2, a markup language table representation 210 can be reduced to a set of table view components 230A, 230B, 230n by way of the table reduction process 220.

Specifically, the table reduction process 220 can reduce the table defined by the markup language table representation 210 into a view of row ranges, a set of row range views, each row range view reflecting only those rows within a selected ranges, and individual record views. The views can be presented to the end user in a logical order wherein the views can be navigably coupled to one another through a table navigation process 240 so that the end user can navigate from an initial row range view, to a row view corresponding to a selected range, to a record view of a selected row from the row view. Additionally, the presentation of ranges, rows and records can be limited by a table filtration process 250. Finally, a table selection process 260 can provide a mechanism for performing conventional table selection functions upon the rows and records of the table represented in the table component views 230A, 230B, 230n.

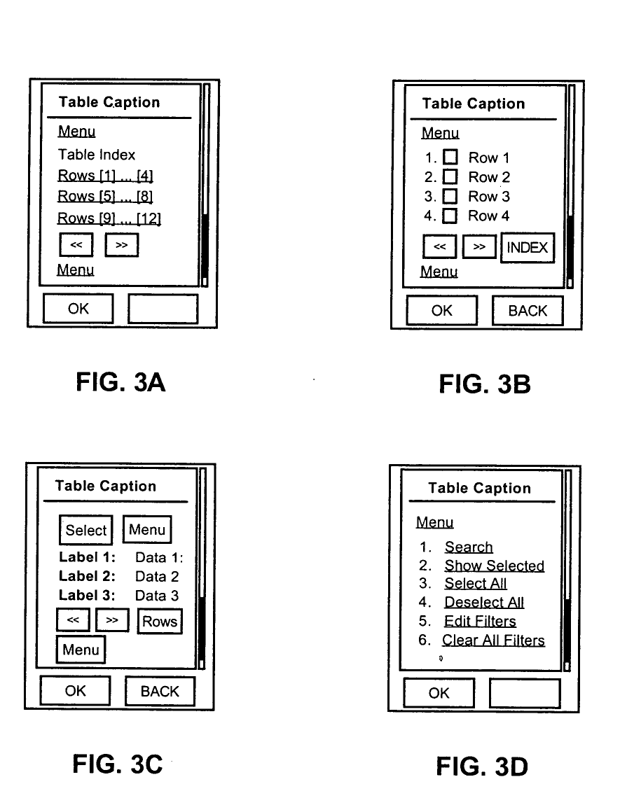

To further illustrate the process by which an end user can navigate the table component views 230A, 230B, 230n of FIG. 2, FIGS. 3A through 3D, taken together, are screen shot representations of a process of navigating a table rendered within the user interface of a limited display device. Specifically, in FIG. 3A, initially the complex table view can be reduced to an index view of row ranges which can be viewed by the end user. Each row range can be selected by the end user to indicate that the end user would prefer to view those rows within the range, while excluding from view all other rows.

Upon selecting a range of rows in FIG. 3A, a set of rows within the selected range can be presented in a separate view as shown in FIG. 3B. Within the row view of FIG. 3B, individual rows can be selected for viewing. Upon selecting a particular one of the individual rows in FIG. 3B, in FIG. 3C a record view can be presented of the selected row in which the record can be viewed, selected and de-selected as the case may be. Importantly, by reducing the complex table into three separate views, the present invention permits the navigation to a desired record through two selective actions without requiring unnecessary scrolling within a display which has been highly constrained by the physical size limitations of a limited display device.

Notably, in addition to the basic navigation between the component views of the complex table as shown in FIGS. 3A through 3C, additional navigation functionality can be provided and accessed by the end user through the menu interface view shown in FIG. 3D. Through the menu interface view, an end user can search for particular data within the table using a conventional “Find” dialog. Furthermore, the end user can select all rows in the table, the end user can deselect all rows in the table, and the end user can view only those rows which have been selected—a sort of convenience filter. Finally, the end user can create, edit and delete filters for presenting only those rows meeting pre-defined criteria.

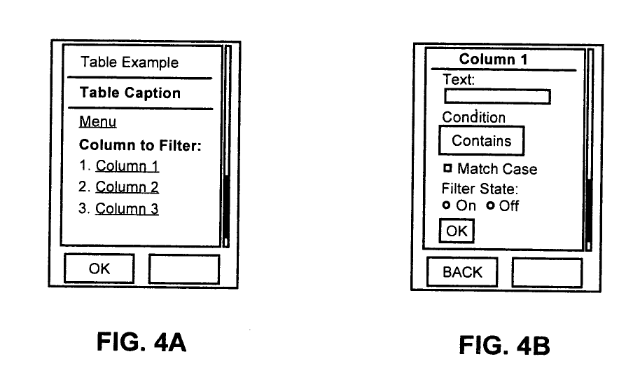

In this regard, FIGS. 4A and 4B, taken together, are screen shot representations of a filtering feature configured for operation with the navigation process of FIGS. 3A through 3D. Specifically, in the select column dialog of FIG. 4A, the end user can be presented with a set of columns configured for filtering. Through the view of FIG. 4A, the end user can select the column to which a filter will be applied. Once selected, a filter criteria dialog, shown in FIG. 4B, can be presented in which the criteria for the filter can be established and in which the filter itself can be activated and deactivated.

Significantly, to achieve the same event model within the application despite the reduction of the complex table into the component views, a controller for the complex table must be enhanced to handle the navigation between the views while remaining transparent to the underlying application. To that end, those events which are unique to the component views and the navigation there between can be processed in the controller and those events which are intended for the complex table are processed accordingly.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A complex table rendering and navigation system comprising:
a plurality of row range views, a plurality of row views, each of said row views having an association with one of said row range views; and a plurality of record views, each of said record views having an association with one of said row views;
a complex table processor coupled to an application server and programmed to reduce a complex table into said row range views, said row views and said record views; and,
a controller configured to map selected events and triggers originating within said views to others of said views, and to map additional selected events and triggers originating within said views to said complex table.

2. The system of claim 1, further comprising a filter management view.

3. A method of enabling complex table navigation in a highly constrained device, the method comprising the steps of:
reducing a complex table defined in markup to a row range view, a set of row views and a set of record views;
navigably linking individual ones of said record views to selected ones of said row views, and further navigably linking individual ones of said row views to selected row ranges disposed in said row range view; and,
presenting said row range view responsive to a request to render said complex table in the highly constrained device.

4. The method of claim 3, further comprising the step of selecting and deselecting individual records in said record views.

5. The method of claim 3, further comprising the steps of:
establishing a set of filter criteria for selecting individual records linked to said row views;
filtering a display of said row views based upon said filter criteria; and, rendering said filtered display in the highly constrained device.

6. The method of claim 3, further comprising the steps of:
receiving a plurality of events generated in said views; and,
handling selected ones of said events without knowledge of an application producing said complex table where said selected ones of said events map to said views and not to said complex table.

7. A method of enabling complex table navigation in a highly constrained device, the method comprising the steps of:
parsing a complex table defined by intent based markup;
producing a reduced view of said complex table, said reduced view comprising a selection of row ranges defining ranges of rows in said complex table, and rendering said reduced view in the highly constrained device;
responsive to a selection of one of said ranges of rows, further producing a further reduced view of said complex table, said further reduced view comprising a selection of rows in said selected one of said ranges of rows, and rendering said further reduced view in the highly constrained device in lieu of said reduced view; and,
responsive to a selection of one of said rows, yet further producing a yet further reduced view of said complex table, said yet further reduced view comprising a record associated with said selected one of said rows, and rendering said yet further reduced view in the highly constrained device in lieu of said further reduced view.

8. A machine readable storage having stored thereon a computer program for enabling complex table navigation in a highly constrained device, the computer program comprising a routine set of instructions for causing the machine to perform the steps of:
reducing a complex table defined in markup to a row range view, a set of row views and a set of record views;
navigably linking individual ones of said record views to selected ones of said row views, and further navigably linking individual ones of said row views to selected row ranges disposed in said row range view; and,
presenting said row range view responsive to a request to render said complex table in the highly constrained device.

9. The machine readable storage of claim 8, further comprising the step of selecting and deselecting individual records in said record views.

10. The machine readable storage of claim 8, further comprising the steps of:
establishing a set of filter criteria for selecting individual records linked to said row views;
filtering a display of said row views based upon said filter criteria; and,
rendering said filtered display in the highly constrained device.

11. The machine readable storage of claim 8, further comprising the steps of:
receiving a plurality of events generated in said views; and,
handling selected ones of said events without knowledge of an application producing said complex table where said selected ones of said events map to said views and not to said complex table.

12. A machine readable storage having stored thereon a computer program for enabling complex table navigation in a highly constrained device, the computer program comprising a routine set of instructions for causing the machine to perform the steps of:
parsing a complex table defined by intent based markup;
producing a reduced view of said complex table, said reduced view comprising a selection of row ranges defining ranges of rows in said complex table, and rendering said reduced view in the highly constrained device;
responsive to a selection of one of said ranges of rows, further producing a further reduced view of said complex table, said further reduced view comprising a selection of rows in said selected one of said ranges of rows, and rendering said further reduced view in the highly constrained device in lieu of said reduced view; and,
responsive to a selection of one of said rows, yet further producing a yet further reduced view of said complex table, said yet further reduced view comprising a record associated with said selected one of said rows, and rendering said yet further reduced view in the highly constrained device in lieu of said further reduced view.
